(19) United States
(12) Patent Application Publication
(10) Pub. No.: US 2026/0120714 A1
(43) Pub. Date: Apr. 30, 2026

(54) Triangular-Shaped Main Pole Design With Natural Leading Edge Tapering For Maximizing The Aerial Density Capacity In Perpendicular Magnetic Recording

(71) Applicant: Headway Technologies, Inc., Milpitas, CA (US)

(72) Inventors: Shehrin Sayed, Fremont, CA (US); Yu-Hsia Chen, Los Altos, CA (US); Yue Liu, Fremont, CA (US); Weihao Xu, San Jose, CA (US); Haowen Ren, Fremont, CA (US); Wenyu Chen, San Jose, CA (US); Yuhui Tang, Milpitas, CA (US)

(21) Appl. No.: 18/930,169

(22) Filed: Oct. 29, 2024

(51) Int. Cl. G11B 5/127; G11B 5/012; G11B 5/82

(52) U.S. Cl. CPC G11B 5/1278; G11B 5/012; G11B 5/82

(57) ABSTRACT

The present embodiments relate to a main pole design comprising a triangular shape and leading edge tapering for maximizing aerial density capacity. The design can include leading edge taper on the LS to create a taper angle on the MP to concentrate the magnetic flux in the MP. The MP can be shifted away from the LG to provide an additional LG portion on a leading side of the MP, and the taper angle can be greater at the additional LG portion than at the LG. The MP design can yield a larger MP surface area at the air bearing surface (ABS) and larger magnetic flux to the media bits.

### TECHNICAL FIELD

Embodiments of the invention relate to the field of perpendicular magnetic recording (PMR) write heads for a hard disk drive (HDD). More particularly, embodiments of the invention relate to a main pole design comprising a triangular shape and leading edge tapering for maximizing aerial density capacity.

### BACKGROUND

Volumes of digital data can be stored on a disk drive, such as a Hard disk drive (HDD). The disk drive can comprise a head that can interact with a magnetic recording medium (e.g., a disk) to read and write magnetic data onto the disk. For instance, the disk drive can include a write head that is positioned near the disk and can modify a magnetization of the disk passing immediately under the write head.

Disk drives can utilize various technologies to write to a disk. For example, perpendicular magnetic recording (PMR) can relate to magnetic bits on a disk are directed perpendicular (e.g., either up or down) relative to the disk surface. PMR recording can increase storage density to the disk by aligning poles of magnetic elements on the disk perpendicularly to the surface of the disk.

### SUMMARY

The present embodiments relate to a main pole design comprising a triangular shape and leading edge tapering for maximizing aerial density capacity. The design can include leading edge taper on the leading shield (LS) to create a taper angle on the main pole (MP) to concentrate the magnetic flux in the MP. The MP can be shifted away from the leading gap (LG) to provide an additional LG portion on a leading side of the MP, and the taper angle can be greater at the additional LG portion than at the LG. The MP design can yield a larger MP surface area at the air bearing surface (ABS) and larger magnetic flux to the media bits.

In a first example embodiment, a write head is provided. The write head can include a main pole (MP) configured to apply a magnetic flux to write media bits to a recording medium. The MP can be triangular in shape. The write head can also include a trailing shield configured to collect back the magnetic flux, a side shield (SS), a leading shield (LS), and a write shield (WS).

The write head can also include a leading edge taper on the LS to create a taper angle on the MP to concentrate the magnetic flux in the MP. The write head can also include a side gap (SG) between the MP and the SS. The write head can also include a leading gap (LG) between the MP and the LS. The MP can be shifted away from the LG to provide an additional LG portion on a leading side of the MP, and the taper angle can be greater at the additional LG portion than at the LG. The write head can also include a coil wrapping around the MP through a magnetic PP3 shield that is configured to direct a write current to saturate MP magnetization.

In some instances, the write head can include a write gap (WG) disposed between the main pole and trailing shield. The WG can include any of a non-magnetic electrical conductor, an insulator, or a magnetic GMR or 2E+n element.

In some instances, the SG is composed of a non-magnetic material that is either a conductor or an insulator, and wherein the LG composed of the same material as the SG.

In some instances, the WG between a hot seed layer and the MP has a length along the SS and LS that is equal to a width of the HS layer.

In some instances, the write head can include an insulator layer disposed between the SG and SS.

In some instances, the MP comprises the triangle shape with a pole width (PWA), a height of the MP equal to a pole thickness (PT), and a side arm angle that is equal to a bevel angle (BA).

In some instances, the MP is shifted away from the LG by shifting a LET mask vertically, wherein after the LET is shifted, the LG and the additional LG portion are deposited to create a trench that defines the triangular shape of the MP.

In some instances, the LG and the additional LG portion are deposited in a narrow SSCD opening to create a trench that defines the triangular shape of the MP.

In some instances, the SSCD opening results in a narrowed PWA after a chemical mechanical polishing (CMP) process, wherein a CMP position is shifted vertically.

In another example embodiment, a device is provided. The device can include a main pole (MP) and a leading shield (LS). The device can also include a leading edge taper on the LS to create a taper angle on the MP. The device can also include a leading gap (LG) between the MP and the LS. The MP can be shifted away from the LG to provide an additional LG portion on a leading side of the MP.

In some instances, the taper angle is greater at the additional LG portion than at the LG between the MP and the LS.

In some instances, the device can also include a trailing shield (TS), a side shield (SS), a write shield (WS), a side gap (SG) between the MP and the SS, and a coil wrapping around the MP through a magnetic PP3 shield.

In some instances, the device can also include a write gap (WG) disposed between the main pole and trailing shield, wherein the WG comprises any of a non-magnetic electrical conductor, an insulator, or a magnetic GMR or 2E+n element, wherein the SG is composed of a non-magnetic material that is either a conductor or an insulator, and wherein the LG composed of the same material as the SG.

In some instances, the WG between a hot seed layer and the MP has a length along the SS and LS that is equal to a width of the HS layer.

In some instances, the MP comprises a triangle shape with a pole width (PWA), a height of the MP equal to a pole thickness (PT), and a side arm angle that is equal to a bevel angle (BA).

In some instances, the MP is shifted away from the LG by shifting a LET mask vertically, wherein after the LET is shifted, the LG and the additional LG portion are deposited to create a trench that defines the triangular shape of the MP.

In some instances, the LG and the additional LG portion are deposited in a narrow SSCD opening to create a trench that defines the triangular shape of the MP, wherein the SSCD opening results in a narrowed PWA after a chemical mechanical polishing (CMP) process, wherein a CMP position is shifted vertically.

In another example embodiment, a method is provided. The method can include providing a leading edge taper (LET) mask adjacent to a main pole (MP) of a write head. The method can also include forming a LET and a leading shield (LS) based on the LET mask that is shifted vertically relative to the MP. The method can also include depositing a leading gap (LG) adjacent to the LS, wherein the MP is shifted away from the LG to provide an additional LG portion on a leading side of the MP, and wherein a taper angle of the LET is greater at the additional LG portion than at the LG.

In some instances, the MP is shifted away from the LG by shifting a LET mask vertically, wherein after the LET is shifted, the LG and the additional LG portion are deposited to create a trench that defines the triangular shape of the MP.

In some instances, the LG and the additional LG portion are deposited in a narrow SSCD opening to create a trench that defines the triangular shape of the MP, wherein the SSCD opening results in a narrowed PWA after a chemical mechanical polishing (CMP) process, wherein a CMP position is shifted vertically.

Other features and advantages of embodiments of the present invention will be apparent from the accompanying drawings and from the detailed description that follows.

### BRIEF DESCRIPTION OF THE DRAWINGS

Embodiments of the present invention are illustrated by way of example and not limitation in the figures of the accompanying drawings, in which like references indicate similar elements and in which:

FIG. 1A is an example Non-Dual-Write-Shield (nDWS) structure, according to embodiments of the present disclosure.

FIG. 1B is an ABS view of the example writer head with a trapezoidal main pole, according to embodiments of the present disclosure.

FIG. 2A illustrates an example MP shape of the ABS of a trapezoidal MP design, according to embodiments of the present disclosure.

FIG. 2B illustrates an example MP shape of the ABS of a triangular MP, according to embodiments of the present disclosure.

FIG. 2C illustrates an example MP shape of the ABS of a MP structure as described herein, according to embodiments of the present disclosure.

FIG. 3A illustrates a perpendicular field from the writer head as a function of PT, according to embodiments of the present disclosure.

FIG. 3B illustrates a perpendicular field from the writer head as a function of PWB for a different PWA group, according to embodiments of the present disclosure.

FIG. 4A is an ABS view and corresponding side view of a MP for some designs with PWB>0, according to embodiments of the present disclosure.

FIG. 4B is an ABS view and corresponding side view of a MP for designs with PWB<0, according to embodiments of the present disclosure.

FIG. 5A is an ABS view and side view of a MP design (PWB>0), according to embodiments of the present disclosure.

FIG. 5B is an ABS view and side view of the MP design as described herein, according to embodiments of the present disclosure.

FIG. 6A illustrates a trapezoidal MP growing with standard SSCD opening and CMP process, according to embodiments of the present disclosure.

FIG. 6B illustrates a narrower SSCD opening to grow the disclosed triangular shaped MP design that can narrow down the PWA, according to embodiments of the present disclosure.

FIG. 6C illustrates a CMP shift to match the target PWA in the present designs, according to embodiments of the present disclosure.

FIG. 7A illustrates PWA, PT, and LG variations in other designs (PWB>0), according to embodiments of the present disclosure.

FIG. 7B illustrates PWA, PT, and LG variations in the present designs (PWB<0), according to embodiments of the present disclosure.

### DETAILED DESCRIPTION

Disk drives can utilize various technologies to write to a disk. For example, perpendicular magnetic recording (PMR) can relate to magnetic bits on a disk are directed perpendicular (e.g., either up or down) relative to the disk surface. PMR recording can increase storage density to the disk by aligning poles of magnetic elements on the disk perpendicularly to the surface of the disk.

Technological advancements in disk drives continually integrate more components into a single device and generates a high volume of electronic data. The data generated per year has been forecasted to reach 175 zettabytes by 2025. The availability of enormous amounts of data is attractive for fueling emerging applications; however, the storage and processing of such a large volume of data is limited by existing technological bottlenecks. To keep up with the growing storage demand, the international data corporation forecasts that over 22 zettabytes of storage capacity may need to be shipped across all media types from 2018 to 2025, and nearly 59% of that expected capacity needs to be supplied from the hard disk drive (HDD) industry. Thus, continuous growth in the areal density capacity (ADC) in HDDs is desired to cope with the growing demand for data storage.

The growth in ADC largely depends on the shrinking media bits and the shrinking write head structures to match the smaller grains. The former can be achieved by larger coercive fields of media grains in perpendicular magnetic recording (PMR). However, the limitations in the ADC scaling can arise due to the degraded performance in shrinking writer heads operating at the GHz frequency. Therefore, there is a growing interest in improving the write head performance in HDD.

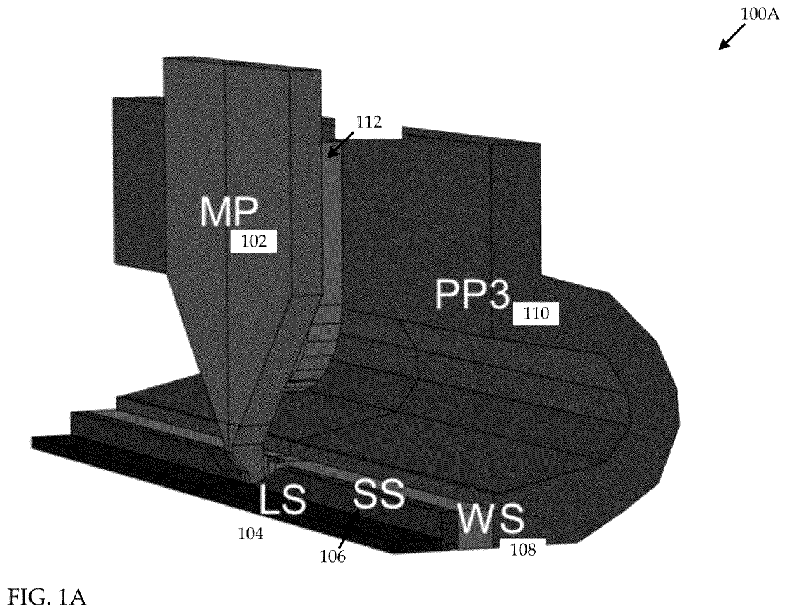

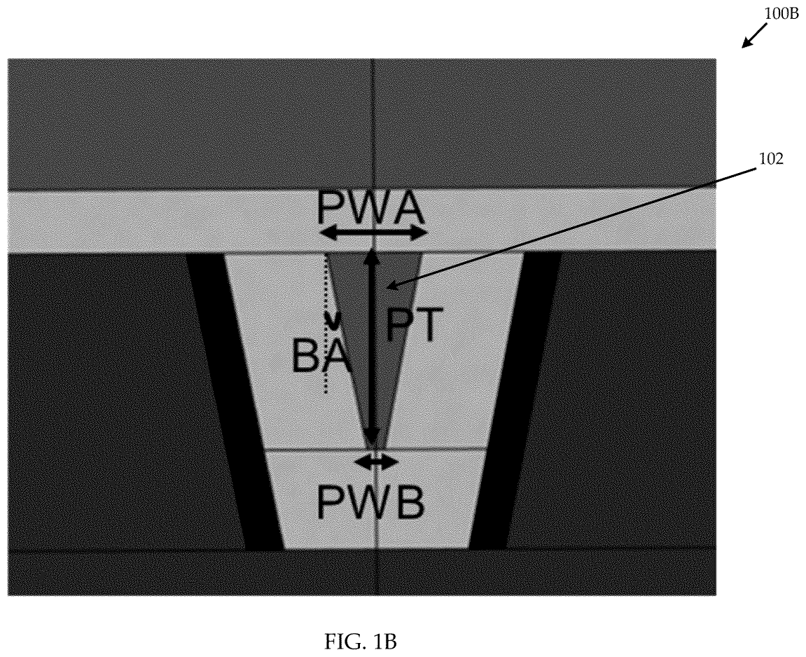

FIG. 1A is an example Non-Dual-Write-Shield (nDWS) structure 100A with a main pole (MP) 102, leading shield (LS) 104, side shield (SS) 106, write shield (WS) 108, top yolk (TY) 112, and return pole (PP3) 110. TY and PP3 can be electrically isolated using a thin insulator. FIG. 1B is an ABS view 100B of the example writer head with a trapezoidal main pole with long base, PWA, short base, PWB, and height, PT.

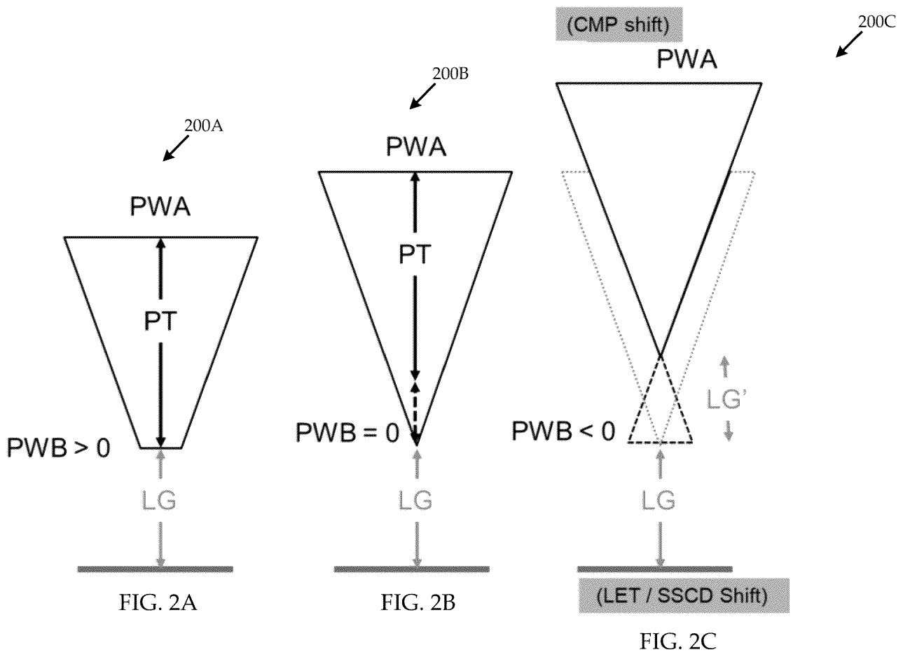

Many write head designs can use a main pole (MP) to apply a perpendicular field to the media bits (see FIG. 1A), and the shape of the MP at the air-bearing surface (ABS) is trapezoidal (see FIG. 1B). The longer base of the trapezoidal MP is called PWA, the shorter base of the trapezoidal MP is called PWB, and the height of the trapezoidal MP is called PT (see FIG. 2A). Thus, the area of the MP at ABS can be defined as:

$$AREA = \frac{1}{2} ( PWA + PWB ) \times PT$$

The angle of the legs of the trapezoid with respect to the height can be called a bevel angle (BA), which can be fixed in process with ±1° of process variation. As the writer head technology is scaling towards a narrower PWA to scale down the erase width of the write bubble, PWB is also narrowing down due to a fixed BA. Thus, the MP area at the ABS can result in a decrease in the total magnetic flux to the media bits.

The present embodiments relate to a main pole design comprising a triangular shape and leading edge tapering for maximizing aerial density capacity. The design can include leading edge taper on the LS to create a taper angle on the MP to concentrate the magnetic flux in the MP. The MP can be shifted away from the LG to provide an additional LG portion on a leading side of the MP, and the taper angle can be greater at the additional LG portion than at the LG. The MP design can yield a larger MP surface area at the air bearing surface (ABS) and larger magnetic flux to the media bits.

FIG. 2A illustrates an example MP shape 200A of the ABS of a trapezoidal MP design. FIG. 2B illustrates an example MP shape 200B of the ABS of a triangular MP. FIG. 2C illustrates an example MP shape 200C of the ABS of a MP structure as described herein.

The trapezoid height, PT, can be increased to compensate for the MP area at the ABS. However, the shape of the MP at the ABS can eventually become triangular (with PWB→0) (see FIG. 2B), and the PT can become constant, determined by the BA and PWA as given by:

$$\frac{PWA}{P T} = 2 tan BA .$$

Thus, the MP area can become constant, and so can the total magnetic flux on the media bits. Moreover, a longer PT can cause additional side-track erasure while operating on the outer disk regime due to an induced skew angle.

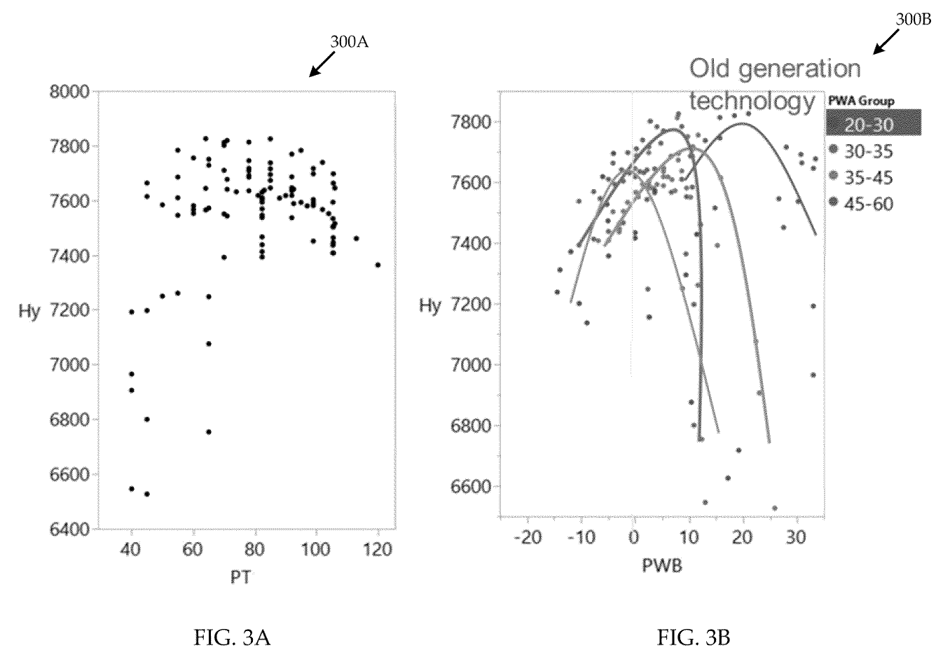

FIG. 3A illustrates a perpendicular field 300A from the writer head as a function of PT. FIG. 3B illustrates a perpendicular field 300B from the writer head as a function of PWB for a different PWA group.

In addition, a longer PT can cause flux crowding at the edges due to shape anisotropy that reduces the overall writability of the writer head. Therefore, increasing PT can help increase the MP area and enhances the writability up to a certain height due to the enhanced magnetic flux (see FIG. 3A). After a specific value of PT, the writability starts degrading (see FIG. 3A). This trade-off can create a maxima point for specific values of PT and PWB, where the performance is optimized.

Other writer head designs can have wider PWA groups, and the optimized performance can occur for a wider PWB. For those designs, further narrowing of PWB corresponds to longer PT and degraded performance due to shape anisotropy-induced writability degradation (FIG. 3B). However, the present designs can use much narrower PWA and optimized performance points for these designs are shifting towards narrower PWB, which corresponds to a relatively longer PT to have a larger MP area but not long enough to cause shape anisotropy degradation. Nevertheless, the benefit from a larger PT or MP area saturates us to hit the triangular limit (i.e., PWB=0) because the BA is relatively fixed. Thus, the PWA-driven scaling can hit the limit.

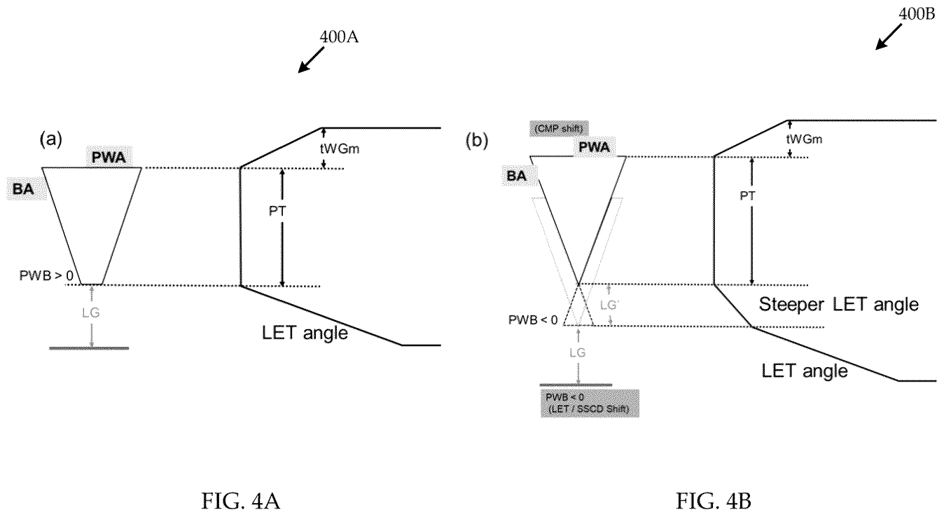

FIG. 4A is an ABS view and corresponding side view of a MP 400A for some designs with PWB>0. FIG. 4B is an ABS view and corresponding side view of a MP 400B for designs with PWB<0.

Here, the present embodiments relate to a new MP design that can drive the scaling of writer heads beyond PWA design groups limited by PWB=0. In this MP design, the MP shape at the ABS can be triangular; however, the triangular MP can be shifted upwards, opening up an additional gap on the leading side (FIG. 2C). The additional leading gap can correspond to an inversion of the PWB, i.e., PWB<0; see dotted lines in FIG. 2C. In the present designs, the additional leading gap can be accompanied by an additional naturally developed leading edge taper (LET) angle that is much shallower than the design LET angle within the design leading gap, see FIG. 4B. Some designs with PWB>0 can have a single LET angle matched with design target which can be around 32˜38°, see FIG. 4A. The naturally developed additional LET angle for PWB<0 can be around 20˜26°. The additional leading gap and LET angle can also result in a thicker MP on the side view (FIG. 4B) and thus have a larger MP volume compared to other designs. For example, a naturally developed LET angle of 23° may lead to about 6% increase in the MP thickness along the down-track direction. The present designs can have an additional leading gap accompanied by an additional steeper LET angle that shifts the optimized performance point towards PWB<0 for further narrower PWA groups, see FIG. 3B. Thus, the present designs can help to drive the scaling of future writer head technologies for enhanced ADC.

The present designs can be coupled with other design topologies, including but not limited to, energy-assisted or current-assisted perpendicular magnetic recording, that contains different designs branches, e.g., a conventional design that injects an assist current between the MP and the trailing shield (TS) through the write gap material, a conventional design where a portion of the assist current flows between MP and the TS through the WG material, a portion of the assist current flows between the MP and the leading shield (LS) through the leading gap material, and the remainder of the assist current follows between the MP and the side shield (SS) through the side gap (SS) material. In some designs, the assist-current between the MP and the SS can be blocked using interfacial oxide layers positioned at the interface of the SS and the side gap material. In some designs, the whole assist-current or a portion of the current can flow through a giant magnetoresistive (GMR) device in the write gap. The disclosed design can have similar reliability margins and device resistance as conventional designs.

The present MP structure can be achieved with two process techniques: (1) LET mask shift and (2) SSCD mask shift. In these processes, the LET can be grown first with the leading shield (LS). Then the SS can be grown according to the BA. Then the leading gap and side gap materials are deposited according to the target thicknesses of the leading gap (LG) and side gap (SG). Finally, the hole created by the leading and side gap materials can be filled up with MP materials and the MP shape depends on the parameters set in the prior process steps.

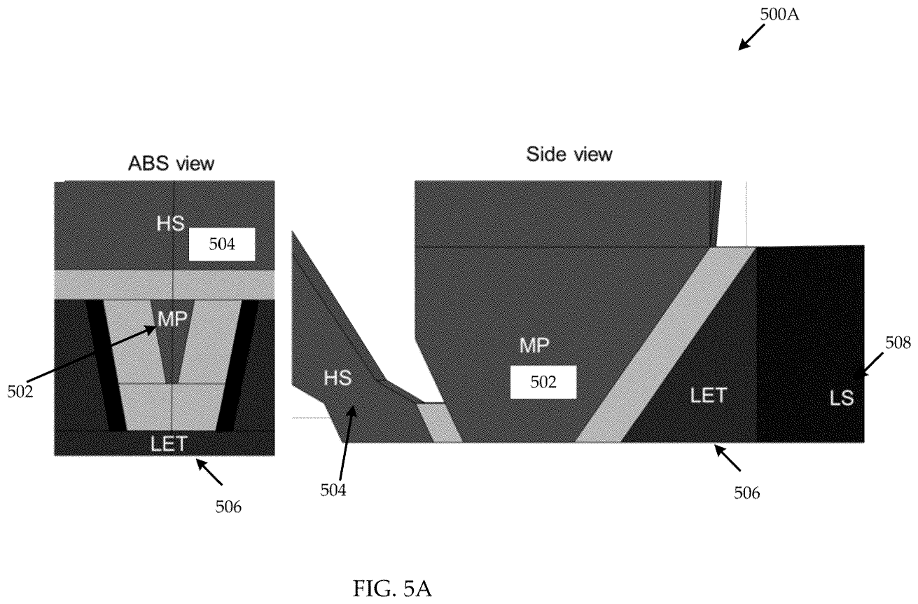

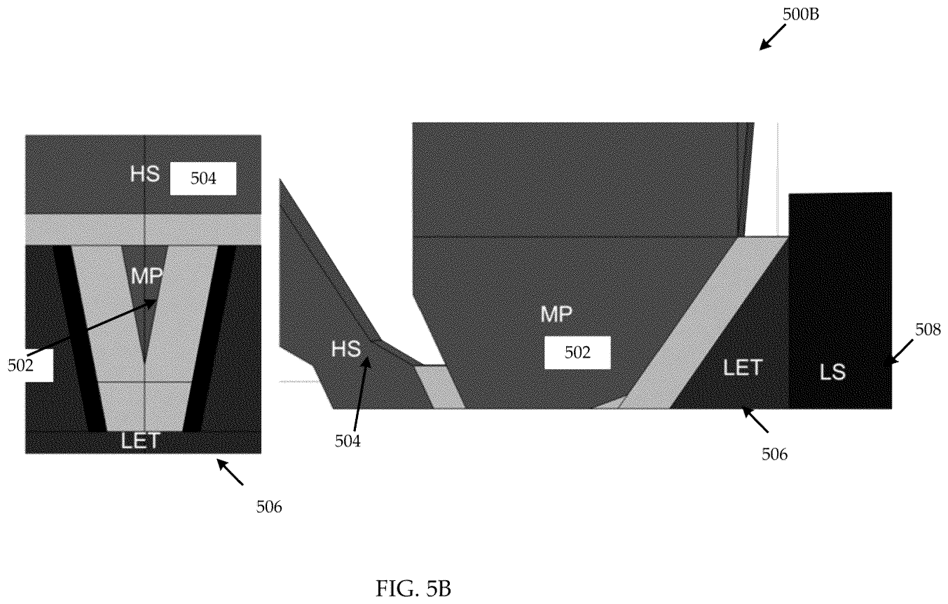

FIG. 5A is an ABS view and side view of a MP design (PWB>0) 500A. FIG. 5B is an ABS view and side view of the MP design 500B as described herein. The triangular MP and associated leading gap opening with additional LET angle can be achieved by a vertical shift of the LET. As shown in FIGS. 5A-5B, the designs can include a MP 502, hot seed (HS) 504, a LET 506, and a LS 508.

In other designs with PWB>0, the LET height can be the same as the LS height, such as is shown in FIG. 5A. The present MP design with PWB<0 can be achieved by shifting the LET vertically, and the LET height can become smaller than the height of the LS, as is shown in FIG. 5B. The LET can be shifted by a number between −10 and +30 nm to achieve a PWB between +2 nm and −10 nm, respectively. After the LS and LET is grown, the LG and SG materials can be deposited which can result in the triangular shape of the MP. The shape of the additional leading gap and associated naturally developed steeper LET angle can be determined by the LG and SG thicknesses and nature of the attack angle on the side shield (SS) side. In this process technique, the LET volume can be decreased and will create a sharp gap between LS and MP, such as in FIG. 5B. Thus, to keep scaling the head designs towards further PWB<0, the LET volume can be lessened and a further steeper gap between MP and LS can be opened.

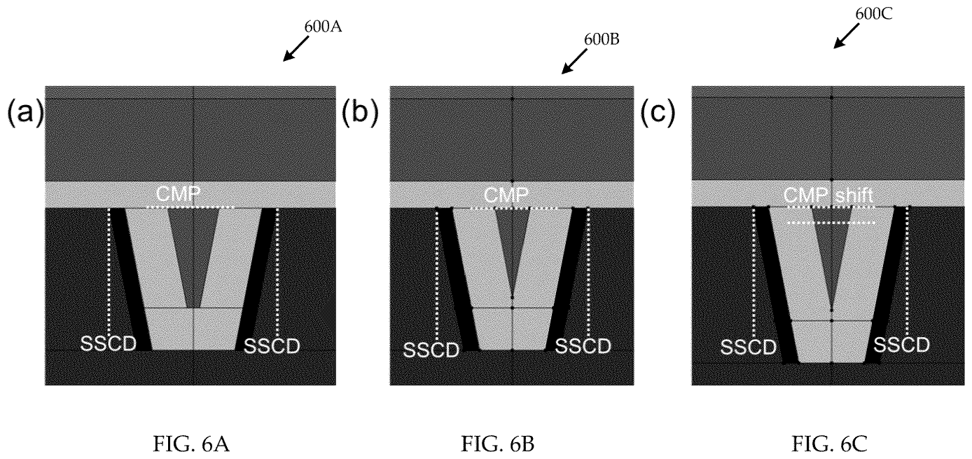

FIG. 6A illustrates a trapezoidal MP growing with standard SSCD opening and CMP process. FIG. 6B illustrates a narrower SSCD opening to grow the disclosed triangular shaped MP design that can narrow down the PWA. FIG. 6C illustrates a CMP shift to match the target PWA in the present designs.

Another process technique to achieve the disclosed MP design is to narrow down the opening between the left and right parts of the SS horizontally (see FIGS. 6A-6C). In this technique, the left and right parts of the SS edges can become closer to each other and LET volume remains the same. However, to maintain the same PWA, the plane of PWA shifts up and SS becomes relatively thicker. Whereas, in the LET shift technique, LET volume can decrease but SS thickness and the PWA plane can remain the same. In this technique, the LET and LS can be first grown on the substrate and then the SS grown using the SSCD mask. Then, the SG and LG materials can be deposited according to the target SG and LG thicknesses which can create a trench for the MP material to be deposited and the trench determines the shape of the MP.

For some MP designs (PWB>0), the SSCD opening is sufficiently large that the trench created by the SG and LG material deposition provides a trapezoidal shape of MP at the ABS, see FIG. 6(a). If the SSCD opening is becomes narrower, the MP shape at the ABS can become triangular (see FIG. 6B) with additional leading gap that corresponds to a steeper natural LET angle. In some process techniques, a chemical mechanical polishing (CMP) can be done on the top of the MP to define the PWA region according to the target value. In the narrow SSCD opening technique as described herein, the PWA can also narrow down at a CMP position, see FIG. 6B. Thus, a need to vertically shift the CMP position upwards to match the target PWA requirements can exist.

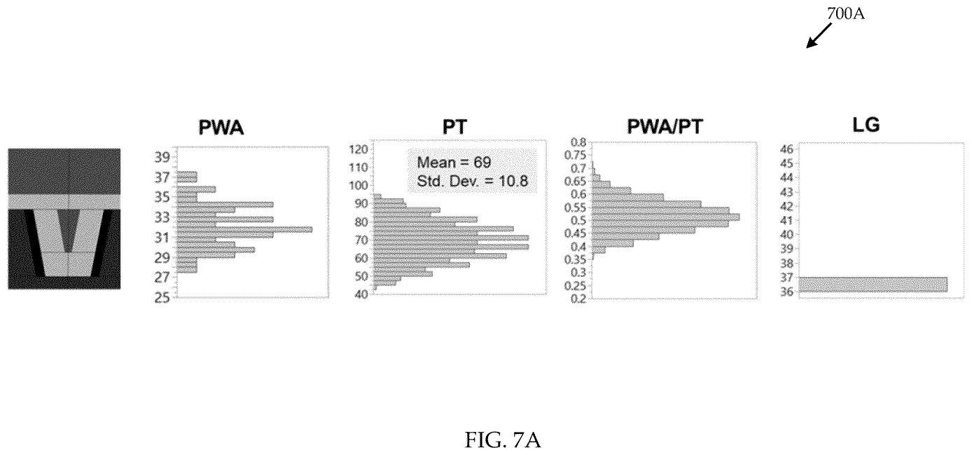

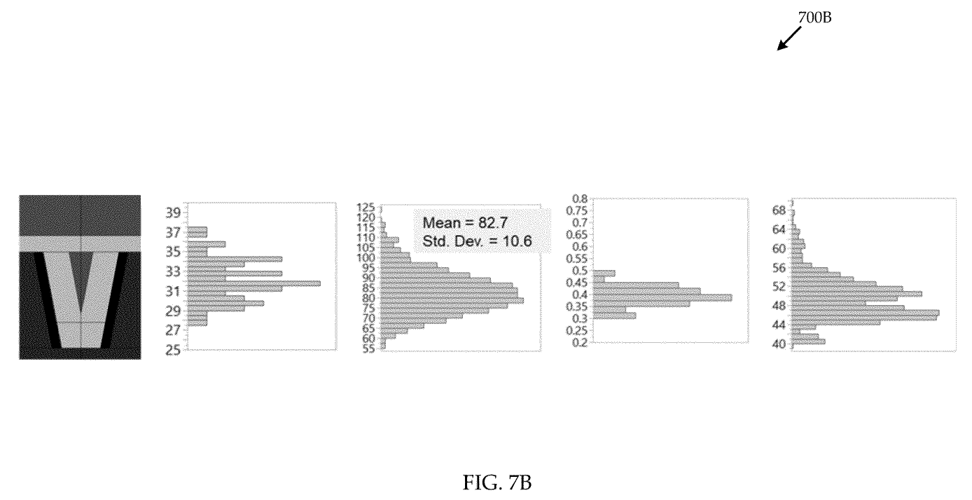

FIG. 7A illustrates PWA, PT, and LG variations in other designs (PWB>0) 700A. FIG. 7B illustrates PWA, PT, and LG variations in the present designs (PWB<0) 700B.

The process variations between other design processes and the present design process can be compared using Monte-Carlo simulations as shown in FIG. 7A-7B. The BA variations in both designs can be about +1° from the nominal value which can be around 11°. The PWA variation can be about +4 nm with nominal PWA set around 30 nm. The other process variation parameters can be set as standard variations typically observed in the other design processes. The expected process variation in PT can be calculated for both the other designs (PWB>0) and the present design (PWB<0). For other designs, the simulation suggests a lower PT nominal of around 69 nm; however, the PT and PWA have independent distributions which results in a larger distribution of the PWA/PT ratios, ranging from 0.35 to 0.75, see FIG. 7A. However, the PT and PWA distributions are correlated for the present designs with longer PT nominal (˜83 nm), which results in a tighter PWA/PT distribution, ranging from 0.3 to 0.5, see FIG. 7B. The PWA/PT ratio distribution can be determined by the tan (BA) distribution. Thus, the present design can provide a tighter distribution for PWA and PT designs which can result in tighter distribution in performance parameters within wafers and among various wafers.

Nevertheless, other design processes can yield a tighter distribution for the LG (see FIG. 7A) with a nominal set near the target value. The present design process can yield a wider distribution for the LG (see FIG. 7B), which can have minimal impact on the writability.

The present embodiments relate to a magnetic writer head design that improves the magnetic flux applied to the media bits to maximize the density capacity (ADC) gain in scaled head structures in hard-disk-drive storage devices.

A first example embodiment can include a baseline non-dual-write-shield (nDWS)-based writer head structure (FIG. 1A). The structure can include a magnetic main pole (MP) that provides a strong and concentrated magnetic flux to write the media bits.

The structure can also include a trailing shield (TS) made of magnetic material that collects back the magnetic flux. The structure can also include a write gap (WG) between the MP and the TS that is comprised of either a non-magnetic electrical conductor, an insulator, or a magnetic GMR or 2E+n element. The structure can also include a side shield (SS), a leading shield (LS), and a write shield (WS) made of magnetic materials that prevents magnetic flux from reaching the medium bits away from the MP tip.

The structure can also include a leading edge taper (LET) on the LS to create a taper angle on the MP that help concentrate the magnetic flux in the MP. The structure can also include a side gap (SG) between the MP and the SS on both sides of the MP tip that can be composed of non-magnetic materials that can be either a conductor or an insulator. The structure can also include a leading gap (LG) between the MP and the LS, that can be composed of the same material as the SG. The structure can also include a coil wrapping around the MP through a magnetic PP3 shield that takes a time-dependent write current to saturate the MP magnetization.

The WG material between the hot seed (HS) and the MP can have a length (along the length of SS and LS) that is equal to the hot seed width. The thickness of the WG material can be equal to the WG thickness of the write head. The height of the WG material can be taller than the eTHd height of the HS (see FIG. 1B).

The SG can have a thin insulator between the SG material and the SS (see FIG. 1B).

The MP structure can be triangular with the base of the triangle equal to the pole width (PWA), height of the triangle equal to the pole thickness (PT), and the side arm angle equal to the bevel angle (BA) (see FIGS. 2B-C).

The MP structure can be different from another MP structure which is trapezoidal with shorter base equal to the shorter pole width (PWB) with PWB>0 (see FIG. 2A). The MP structure can have a longer PT which yields larger MP surface area at the air bearing surface (ABS) for a given PWA design target (see FIGS. 2B-C). The larger MP surface area can provide larger magnetic flux to the media bits.

The MP can be thicker on the side view (see FIG. 4B), which can result in larger MP volume and larger flux concentration as compared to the other MP designs.

The MP structure may open up an additional LG which correspond to PWB≤0 (see FIGS. 2B-C). The additional LG accompanies an additional steeper LET angle that is developed naturally during the growth process (see FIG. 4B).

The additional LG and the corresponding steeper LET angle can enhance writability and shifts the optimized performance regime towards PWB<0 for narrower PWA design target (see FIG. 3).

The MP design can be achieved by shifting the LET mask vertically (see FIG. 5). After the LET is shifted down, the gap materials can be deposited according to the design specifications. The deposited gap materials can create a trench that defines the shape of the MP.

The writer head LET layer volume can be reduced with the LET shift which accompanies a sharp gap between the LS and MP (see FIG. 5).

The MP design can also be achieved by a narrower SSCD opening compared to other processes (see FIG. 6). The deposition of the gap materials within the narrower SSCD opening can create a trench that can define the triangular shape of the MP with an additional naturally grown LET.

The narrower SSCD opening can result in a narrower PWA after the chemical mechanical polishing (CMP) step (see FIG. 6B).

The CMP position can be vertically shifted upwards to match the PWA requirements (see FIG. 6C).

The process variation of the PWA and PT of the MP design and can be tighter than other designs and processes (see FIGS. 7A-B). The PWA and PT distributions for the MP design can be correlated which can result in a tighter PWA/PT distribution as compared to other designs. This tighter distribution can result in tighter performance parameters with less variations.

The process variation of the LG and SG of the MP design and corresponding processes can be wider than other designs and processes (see FIGS. 7A-7B). However, such variations can have minimal effect on the performance parameter distribution.

It will be understood that terms such as “top,” “bottom,” “above,” “below,” and x-direction, y-direction, and z-direction as used herein as terms of convenience that denote the spatial relationships of parts relative to each other rather than to any specific spatial or gravitational orientation. Thus, the terms are intended to encompass an assembly of component parts regardless of whether the assembly is oriented in the particular orientation shown in the drawings and described in the specification, upside down from that orientation, or any other rotational variation.

It will be appreciated that the term “present invention” as used herein should not be construed to mean that only a single invention having a single essential element or group of elements is presented. Similarly, it will also be appreciated that the term “present invention” encompasses a number of separate innovations, which can each be considered separate inventions. Although the present invention has been described in detail with regards to the preferred embodiments and drawings thereof, it should be apparent to those skilled in the art that various adaptations and modifications of embodiments of the present invention may be accomplished without departing from the spirit and the scope of the invention. Accordingly, it is to be understood that the detailed description and the accompanying drawings as set forth hereinabove are not intended to limit the breadth of the present invention, which should be inferred only from the following claims and their appropriately construed legal equivalents.

1. A write head comprising:
a main pole (MP) configured to apply a magnetic flux to write media bits to a recording medium, wherein the MP is triangular in shape;
a trailing shield configured to collect back the magnetic flux;
a side shield (SS), a leading shield (LS), and a write shield (WS);
a leading edge taper on the LS to create a taper angle on the MP to concentrate the magnetic flux in the MP;
a side gap (SG) between the MP and the SS;
a leading gap (LG) between the MP and the LS, wherein the MP is shifted away from the LG to provide an additional LG portion on a leading side of the MP, and wherein the taper angle is greater at the additional LG portion than at the LG; and
a coil wrapping around the MP through a magnetic PP3 shield that is configured to direct a write current to saturate MP magnetization.

2. The write head of claim 1, further comprising:
a write gap (WG) disposed between the main pole and trailing shield, wherein the WG comprises any of a non-magnetic electrical conductor, an insulator, or a magnetic GMR or 2E+n element.

3. The write head of claim 1, wherein the SG is composed of a non-magnetic material that is either a conductor or an insulator, and wherein the LG composed of the same material as the SG.

4. The write head of claim 1, wherein the WG between a hot seed layer and the MP has a length along the SS and LS that is equal to a width of the HS layer.

5. The write head of claim 1, further comprising:
an insulator layer disposed between the SG and SS.

6. The write head of claim 1, wherein the MP comprises the triangle shape with a pole width (PWA), a height of the MP equal to a pole thickness (PT), and a side arm angle that is equal to a bevel angle (BA).

7. The write head of claim 1, wherein the MP is shifted away from the LG by shifting a LET mask vertically, wherein after the LET is shifted, the LG and the additional LG portion are deposited to create a trench that defines the triangular shape of the MP.

8. The write head of claim 1, wherein the LG and the additional LG portion are deposited in a narrow SSCD opening to create a trench that defines the triangular shape of the MP.

9. The method of claim 8, wherein the SSCD opening results in a narrowed PWA after a chemical mechanical polishing (CMP) process, wherein a CMP position is shifted vertically.

10. A device comprising:
a main pole (MP);
a leading shield (LS);
a leading edge taper on the LS to create a taper angle on the MP; and
a leading gap (LG) between the MP and the LS, wherein the MP is shifted away from the LG to provide an additional LG portion on a leading side of the MP.

11. The device of claim 10, wherein the taper angle is greater at the additional LG portion than at the LG between the MP and the LS.

12. The device of claim 10, further comprising:
a trailing shield (TS);
a side shield (SS),
a write shield (WS);
a side gap (SG) between the MP and the SS; and
a coil wrapping around the MP through a magnetic PP3 shield.

13. The device of claim 12, further comprising:
a write gap (WG) disposed between the main pole and trailing shield, wherein the WG comprises any of a non-magnetic electrical conductor, an insulator, or a magnetic GMR or 2E+n element, wherein the SG is composed of a non-magnetic material that is either a conductor or an insulator, and wherein the LG composed of the same material as the SG.

14. The write head of claim 1, wherein the WG between a hot seed layer and the MP has a length along the SS and LS that is equal to a width of the HS layer.

15. The write head of claim 1, wherein the MP comprises a triangle shape with a pole width (PWA), a height of the MP equal to a pole thickness (PT), and a side arm angle that is equal to a bevel angle (BA).

16. The write head of claim 1, wherein the MP is shifted away from the LG by shifting a LET mask vertically, wherein after the LET is shifted, the LG and the additional LG portion are deposited to create a trench that defines the triangular shape of the MP.

17. The write head of claim 1, wherein the LG and the additional LG portion are deposited in a narrow SSCD opening to create a trench that defines the triangular shape of the MP, wherein the SSCD opening results in a narrowed PWA after a chemical mechanical polishing (CMP) process, wherein a CMP position is shifted vertically.

18. A method comprising:
providing a leading edge taper (LET) mask adjacent to a main pole (MP) of a write head;
forming a LET and a leading shield (LS) based on the LET mask that is shifted vertically relative to the MP;
depositing a leading gap (LG) adjacent to the LS, wherein the MP is shifted away from the LG to provide an additional LG portion on a leading side of the MP, and wherein a taper angle of the LET is greater at the additional LG portion than at the LG.

19. The method of claim 18, wherein the MP is shifted away from the LG by shifting a LET mask vertically, wherein after the LET is shifted, the LG and the additional LG portion are deposited to create a trench that defines the triangular shape of the MP.

20. The method of claim 18, wherein the LG and the additional LG portion are deposited in a narrow SSCD opening to create a trench that defines the triangular shape of the MP, wherein the SSCD opening results in a narrowed PWA after a chemical mechanical polishing (CMP) process, wherein a CMP position is shifted vertically.
